(19) United States
(12) Patent Application Publication
(10) Pub. No.: US 2022/0314846 A1
(43) Pub. Date: Oct. 6, 2022

(54) REAR LINK ASSEMBLY FOR VEHICLE SEAT AND METHOD OF MANUFACTURING SAME

(71) Applicant: DAS CO., LTD., Gyeongju-si (KR)

(72) Inventor: Jae Yeol LEE, Ulsan (KR)

(21) Appl. No.: 17/586,208

(22) Filed: Jan. 27, 2022

(30) Foreign Application Priority Data
Mar. 31, 2021 (KR) 10-2021-0041734

(51) Int. Cl. B60N 2/235; B21J 5/12; B60N 2/68; B21J 7/18

(52) U.S. Cl. CPC B60N 2/2352; B21J 5/12; B60N 2/68; B21J 7/18

(57) ABSTRACT

Disclosed herein is a rear link assembly for a vehicle seat. The rear link assembly includes; a pipe provided with first and second stop protrusion portions in the vicinity of each end thereof; a link bracket fixed between the first and second stop protrusion portions; a serration formed by repeatedly forming pluralities of protrusions and depressions on the inner circumferential surface of the coupling hole of the link bracket into which the pipe is inserted; stepped portions formed on the protrusions; and a first introduced volume portion formed in such a manner that one side of the second stop protrusion portion is deformed and introduced into the stepped portions.

### CROSS-REFERENCE TO RELATED APPLICATION

This application claims priority from the benefit of Korean Patent Application No. 10-2021-0041734, filed on Mar. 31, 2021, which is hereby incorporated by reference for all purposes as if fully set forth herein.

### BACKGROUND

### 1. Technical Field

The present invention relates generally to a rear link assembly for a vehicle seat and a method of manufacturing the rear link assembly, and more particularly to a rear link assembly for a vehicle seat in which the coupling strength between link brackets and a pipe is enhanced, and a method of manufacturing the rear link assembly.

### 2. Description of the Related Art

A car seat having a height adjustment function forms a four-bar link structure in such a manner that front link brackets and rear link brackets are rotatably installed between seat rails and a cushion frame. The height of the seat can be adjusted by driving one link bracket, which belongs to both the rear link brackets in the rear of the seat and on which a sector gear is formed, with a motor.

The rear link brackets are coupled to a pipe connecting the rear ends of both sides of the cushion frame, and form a rear link assembly. Each of the rear link brackets is fixed between two stop protrusion portions formed on the pipe by swaging.

FIG. 1 shows a conventional rear link bracket. A coupling hole 2 configured such that a pipe is inserted thereinto is formed in one end portion of a link bracket 1. A serration 2a is formed on the inner circumferential surface of the coupling hole 2. The serration 2a includes protrusions 2aa protruding toward the center of the coupling hole 2 and depressions 2ab each formed to be concave on both sides of each of the protrusions 2aa.

As shown in FIG. 2, the link bracket 1 is brought into close contact with a first stop protrusion portion 3a formed in the pipe 3 first (through primary swaging). Then, when a second stop protrusion portion 3b is formed (through secondary swaging), a portion of the volume of the second stop protrusion portion 3b is deformed inward and introduced into the inside of the serration 2a. This is intended to improve the coupling strength between the link bracket 1 and the pipe 3, particularly the strength in the rotation direction used to suppress the rotation of the link bracket 1 around the pipe 3 (in FIG. 2, reference numeral 4 denotes a die, reference numeral 5 denotes a punch, and reference numeral 6 denotes an inner diameter guide).

However, when the serration 2a is formed on the link bracket 1 by piercing, a die roll (the deformed sides of the protrusions 2aa of the serration in a piercing direction) D occurs, and a gap G is generated between the link bracket 1 and the second stop protrusion portion 3b by the die roll D.

Due to the gap G, when the second stop protrusion portion 3b is formed, the coupling between the link bracket 1 and the pipe 3 attributable to the introduction of a volume into the serration 2a is not appropriately performed.

In addition, since the punch 5 forming the second stop protrusion portion 3b comes into surface contact with one side of the link bracket 1, there is a limitation to the compressing of the second stop protrusion portion 3b. Accordingly, a portion of the volume of the second stop protrusion portion 3b is not sufficiently introduced, and thus the firm coupling between the link bracket 1 and the pipe 3 is not achieved.

Accordingly, the coupling strength in the rotational direction between the link bracket 1 and the pipe 3 is reduced. Accordingly, a problem arises in that separation is generated in the rotational direction between the link bracket 1 and the pipe 3 due to the torsional moment generated when the height of the seat is adjusted.

Therefore, when the height of the seat is adjusted, operation delay, vibration, noise, etc. are generated due to the separation, so that the operation of adjusting the height of the seat is not smoothly performed and an unsatisfactory feeling of operation is given to a user.

Moreover, due to the occurrence of the separation described above, full inspection is performed using an automatic inspection machine after the manufacture of the rear link assembly, and accordingly a problem arises in that the manufacturing costs of the rear link assembly are increased.

### PRIOR ART DOCUMENT

Patent document: Korean Patent Application Publication No. 2018-0004455 (published on Jan. 12, 2018)

### SUMMARY

The present invention has been conceived to overcome the above-described problems, and an object of the present invention is to provide a rear link assembly for a vehicle seat in which the coupling strength between link brackets and a pipe is enhanced, so that rotational separation is prevented from occurring between the link brackets and the pipe, and a method of manufacturing the rear link assembly.

In order to accomplish the above object, the present invention provides a rear link assembly for a vehicle seat, the rear link assembly including; a pipe provided with a first and a second stop protrusion portions in the vicinity of each end thereof; a link bracket fixed between the first and second stop protrusion portions; a serration formed by repeatedly forming pluralities of protrusions and depressions on the inner circumferential surface of the coupling hole of the link bracket into which the pipe is inserted; stepped portions formed on the protrusions; and a first introduced volume portion formed in such a manner that one side of the second stop protrusion portion is deformed and introduced into the stepped portions.

The rear link assembly may further include a second introduced volume portion formed in such a manner that one side of the second stop protrusion portion is deformed and introduced into the depressions.

The inner corners of the stepped portions may be formed at a right angle.

A wall surface connecting the stepped portions and the outer surface of the coupling hole may be formed as a flat surface; and the flat surface may be a flat surface in contact with a circumferential surface having the same center as the center of the coupling hole.

In addition, the present invention provides a method of manufacturing a rear link assembly for a vehicle seat, including: a first swaging step of forming a first stop protrusion portion in a portion in the vicinity of each end of a pipe; a link bracket installation step of installing a link bracket at the end of the pipe so that one side of the link bracket is supported on the first stop protrusion portion; a second swaging step of forming a second stop protrusion portion configured to come into close contact with the other side of the link bracket; and a step of forming a first introduced volume portion in such a manner that the second stop protrusion portion is deformed and introduced into the stepped portions formed in the protrusions of the serration formed on the coupling hole of the link bracket.

A circular pressing protrusion may be formed on an end surface of the punch used in the second swaging step, and may press the second stop protrusion portion toward the serration.

A coupling hole configured such that the pipe is inserted into the link bracket therethrough, a serration formed on the inner circumferential surface of the coupling hole, and stepped portions formed on the protrusions of the serration may be formed; and the coupling hole, the serration, and the stepped portions may be simultaneously formed by a single piercing process.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a front view of a link bracket and an enlarged view of the serration of a coupling hole according to prior art;

FIG. 2 is a sectional view illustrating the secondary swaging step of a conventional method of manufacturing a rear link assembly;

FIG. 3 is a perspective view of a rear link assembly according to the present invention and an enlarged view of the main portion thereof;

FIG. 4 is a front view of a link bracket and an enlarged view of the serration of a coupling hole according to the present invention;

FIG. 5 is a perspective view of an end of a punch used in the secondary swaging step of a method for manufacturing a rear link according to the present invention;

FIG. 6 is a sectional view illustrating the secondary swaging step of a method for manufacturing a rear link according to the present invention; and

FIGS. 7 and 8 are sectional views of the coupling portion between a link bracket and a pipe in a rear link assembly according to the present invention, wherein FIG. 7 is a sectional view of a protrusion of a serration and FIG. 8 is a sectional view of a depression of the serration.

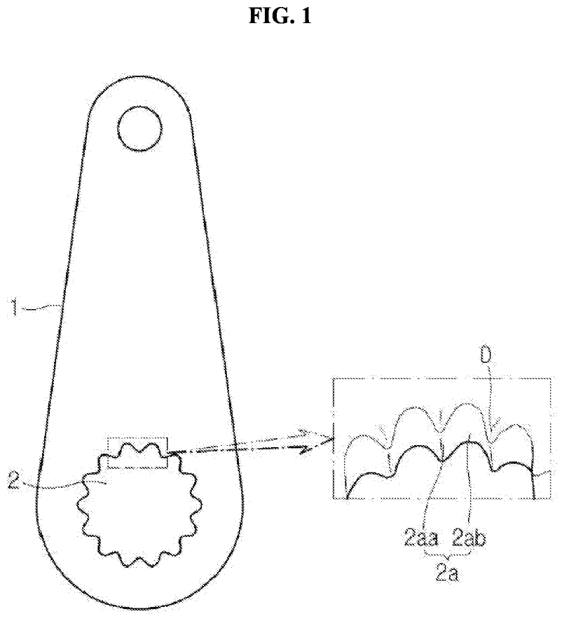

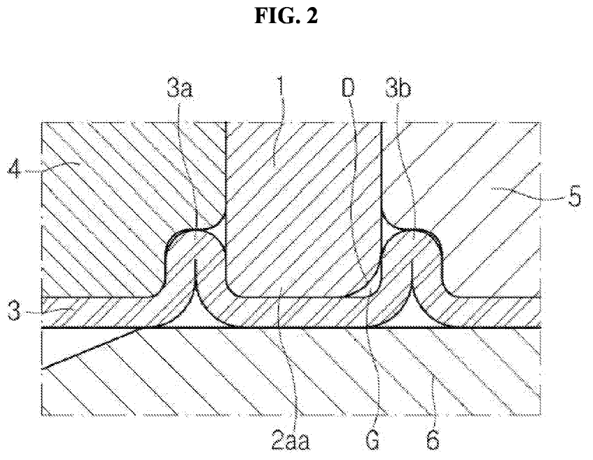

### DETAILED DESCRIPTION

The present invention may be subjected to various modifications and may have various embodiments. Specific embodiments will be illustrated in the drawings and described in detail. However, this is not intended to limit the present invention to the specific embodiments, but it should be understood that the present invention includes all modifications, equivalents and substitutes included in the spirit and scope of the present invention. The thicknesses of lines or the sizes of components shown in the accompanying drawings may be exaggerated for clarity and convenience of description.

Furthermore, the terms to be described later are terms defined by taking into consideration the functions thereof in the present invention, which may vary depending on the intention of a user or operator or a precedent. Therefore, the definitions of these terms should be made based on the context throughout the present specification.

Preferred embodiments according to the present invention will be described in detail below with reference to the accompanying drawings.

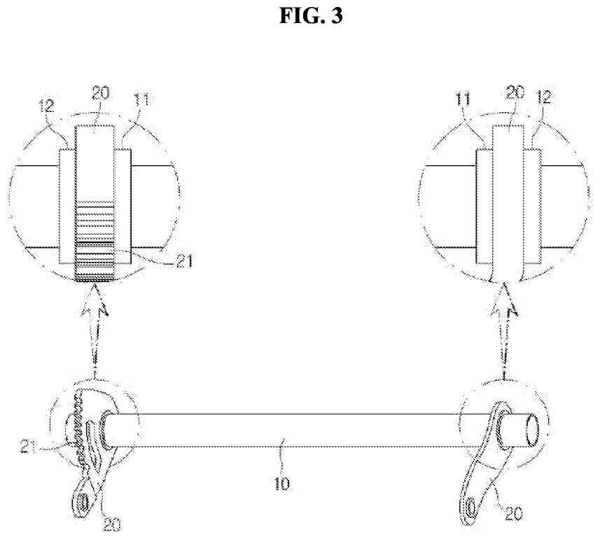

FIG. 3 is a perspective view of a rear link assembly for a vehicle seat according to the present invention and an enlarged view of the main portion thereof.

The rear link assembly includes a pipe 10, and link brackets 20 mounted on both sides of the pipe 10.

The pipe 10 connects the rear ends of a cushion frame on both sides of the seat, and is rotatably installed to the cushion frame.

The link brackets 20 are fixed to the pipe 10 in a non-rotatable state, and the ends of the link brackets 20 opposite to the portions of the link brackets 20 coupled to the pipe 10 are rotatably connected to the upper rail (moving rail) of seat rails.

A sector gear 21 is disposed on one of the link brackets 20, the sector gear 21 engages with a pinion installed on the cushion frame of the seat, and the pinion is driven by a motor installed on the cushion frame. Accordingly, the height of the seat may be adjusted by rotating the one link bracket 20 in the vertical direction with a motor.

The link bracket 20 is fixed between a first stop protrusion portion 11 and a second stop protrusion portion 12 formed on the pipe 10. The first stop protrusion portion 11 and the second stop protrusion portion 12 are formed by a primary swaging step and a secondary swaging step, respectively.

Swaging is the operation of forming a disk-shaped protrusion portion protruding radially outwardly from a pipe by compressing the pipe in its longitudinal direction to overlap a portion of the body of the pipe while expanding outward. Swaging is implemented by a pipe swaging apparatus, including a clamping part (not shown) configured to fasten a pipe, a die fixed to the clamping part, and a punch equipped with an inner diameter guide. Since such a pipe swaging method and apparatus are well-known prior art, a detailed description thereof will be omitted.

First, the first stop protrusion portion 11 is formed by performing a primary swaging step on both sides of the pipe 10.

The second stop protrusion portion 12 is formed by inserting the link bracket 20 over one end of the pipe 10 (the end of the pipe 10 is inserted into the coupling hole 22 of the link bracket 20), bringing one side surface of the link bracket 10 into close contact with the first stop protrusion portion 11 formed earlier, and then performing a secondary swaging step.

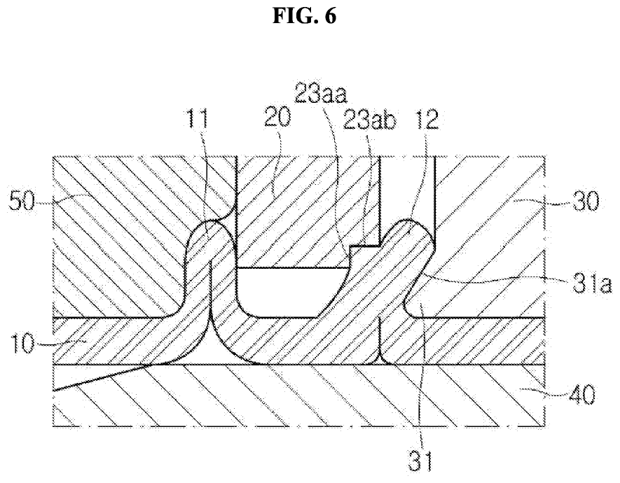

The second stop protrusion portion 12 is formed by pressing the pipe 10 with a punch 30 in the state in which the first stop protrusion portion 11 and the link bracket 20 are supported by the die 50, as shown in FIG. 6. A portion of the volume of the second stop protrusion portion 12 is introduced into the coupling hole 22 of the link bracket 20 while being deformed by a pressing force.

Therefore, the link bracket 20 is firmly fixed between the first stop protrusion portion 11 and the second stop protrusion portion 12 in the axial and rotational directions of the pipe 10.

The following structure is applied to the link bracket 20 in order to enhance rotational direction coupling strength.

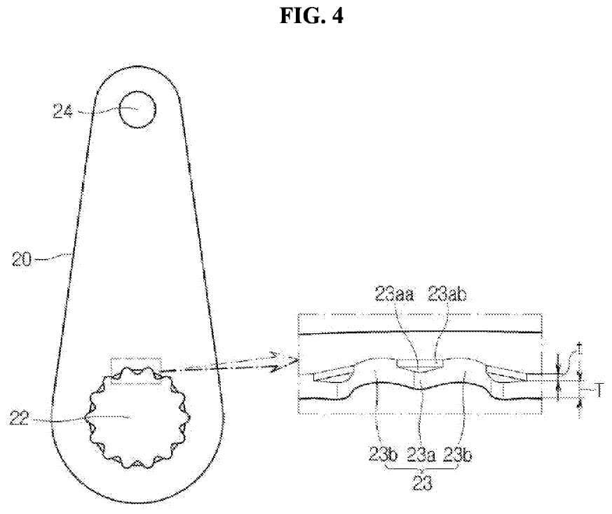

As shown in FIG. 4, both ends of the link bracket 20 have round shapes, and the radii of the round portions are different from each other. The portion having a larger radius is a portion connected to the pipe 10, and the coupling hole 22 configured such that the pipe 10 is inserted thereinto is formed in this portion. A hinge hole 24 is formed in the opposite portion having a smaller radius to be hingedly connected to the upper rail of the seat rails.

A serration 23 in which pluralities of protrusions 23a and depressions 23b are continuously and repeatedly formed is formed on the inner circumferential surface of the coupling hole 22.

The protrusions 23a protrude toward the center of the coupling hole 22, and the depressions 23b are concave portions between the protrusions 23a.

Stepped portions 23aa are formed on the one-side surfaces of the protrusions 23a (the surfaces of the protrusions 23a facing the second stop protrusion portion 12 in the secondary swaging step).

Each of the stepped portions 23aa is formed in such a manner that a portion (corresponding to a step thickness t) facing the second stop protrusion portion 12 is removed from the thickness T (which is the same as the thickness of the link bracket 20) of a corresponding protrusion 23a and the inner corner thereof is formed at a right angle. One side surface of the stepped portion 23aa, i.e., a wall surface 23ab connecting the protrusion 23a and the outer surface of the coupling hole 22, is formed as a flat surface.

The wall surface 23ab is formed as a plane in contact with a circumferential surface having the same center as the center of the coupling hole 22.

The step portion 23aa may be formed by cutting or forging. In the case of the cutting method, after the serration 23 has been formed on the link bracket 20, one side of each of the protrusions 23a is cut and removed.

Even in the case of the forging method, the stepped portions 23aa may be formed by forging one side of each of the protrusions 23a after the formation of the serration 23.

In addition, in the case of the forging method, the coupling hole 22, the serration 23, and the stepped portions 23aa may all be formed by a single piercing process. In other words, the coupling hole 22, the serration 23 and the stepped portions 23aa may be formed together by using a piercing punch having a shape corresponding to the serration 23 and the stepped portions 23aa. In this way, when the coupling hole 22, the serration 23, and the stepped portions 23aa are all formed by a single piercing process, the manufacture of the link bracket 20 may be performed considerably fast and simply.

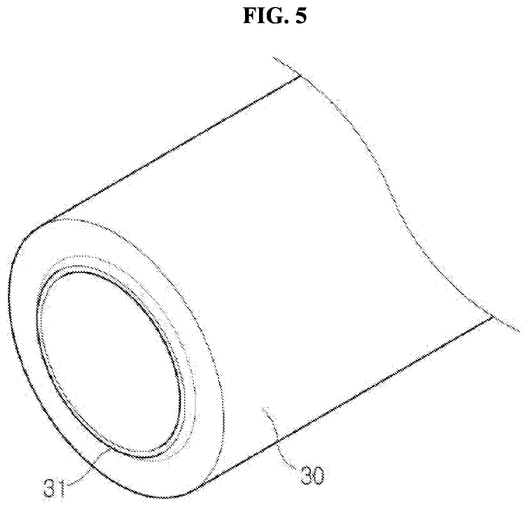

Meanwhile, a pressing protrusion 31 is formed on the second stop protrusion portion pressing surface of a punch 30 used in the secondary swaging step of forming the second stop protrusion portion 12 in order to more effectively press a portion corresponding to the serration 23, as shown in FIGS. 5 and 6.

The pressing protrusion 31 is formed in a circular ring shape as a whole along the overall circumference of the inlet of the inner diameter of the punch 30.

Furthermore, the pressing protrusion 31 is formed in such a manner that the radially inner end of the punch 30 protrudes most outward and the protruding end is connected to the end face of the punch 30 in the form of an inclined surface 31a. In other words, the pressing protrusion 31 has an approximately right-angled triangular cross-sectional shape using the inclined surface 31a as its hypotenuse.

The state in which the secondary swaging step is performed using the punch 30 having the pressing protrusion 31 formed on the end surface as described above is shown in FIG. 6.

The pipe 10 is inserted and fixed to the inside of the die 50, and the first stop protrusion portion 11 formed in the primary swaging step is supported on the die 50. In addition, one side of the link bracket 20 installed on the pipe 10 after the primary swaging step is also supported by the die 50.

In the above state, the secondary swaging step is performed. An end of the pipe 10 is introduced into an insertion hole between the punch 30 and an inner diameter guide 40, and in that state, the punch 30 and the inner diameter guide 40 assembly press the end of the pipe 10 while moving toward the die 50. Accordingly, the body of the pipe 10 is folded and protrudes into the space between the link bracket 20 and the punch 30 and forms the second stop protrusion portion 12. In this case, the inner diameter guide 40 supports the inner diameter surface of the pipe 10 so that the pipe 10 is prevented from being deformed inward and maintains a normal circular tube shape.

When the punch 30 continues to move forward, the pressing protrusion 31 strongly presses one side of the second stop protrusion portion 12. Accordingly, a portion of the body of the second stop protrusion portion 12 is pushed into the inside of the coupling hole 22 and forms a part to be caught on the serration 23.

The introduction of the volume into the coupling hole 22 is performed over all the protrusions 23a and depressions 23b of the serration 23.

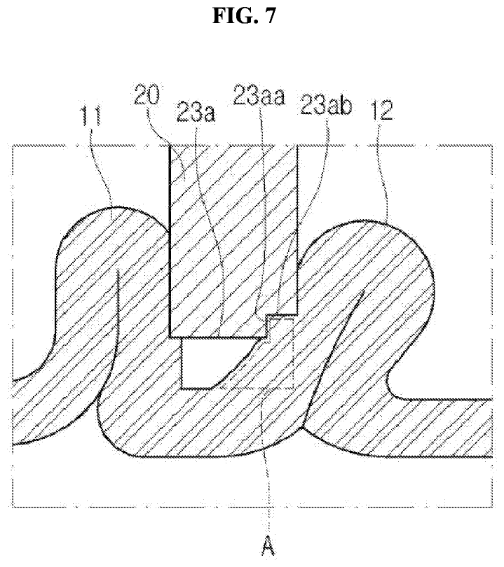

FIG. 7 is a sectional view of the protrusion 23a in the above-descried assembled state of the link bracket.

A volume is introduced as the second stop protrusion portion 12 is deformed in the inner direction of the coupling hole 22 by the pressing protrusion 31 of the punch 30. In this case, an introduced volume portion over the range of the protrusion 20 will be referred to as a first introduced volume portion A.

The upper portion of the first introduced volume portion A completely fills the insides of the stepped portions 23aa, and is introduced into the space below the ends of the protrusions 23a in a gently inclined form. In this case, the wall surfaces 23ab of the stepped portions 23a include flat surfaces in contact with a circumferential surface having the same center as the center of the coupling hole 22. Furthermore, the upper portion of the first introduced volume portion A is in strong surface contact with the wall surface 23ab. Accordingly, the rotation of the link bracket 20 with respect to the pipe 10 may be strongly suppressed.

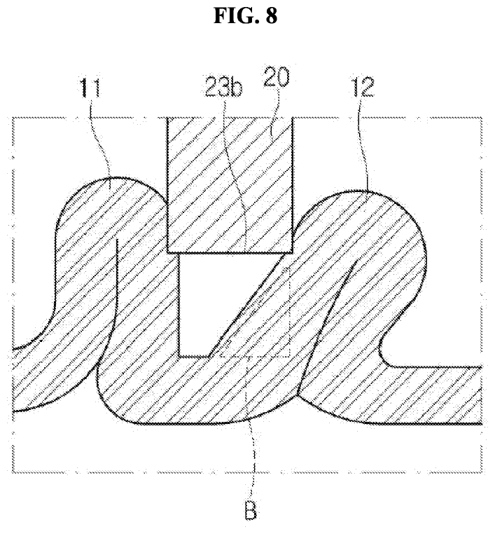

FIG. 8 is a sectional view of the depression portion 23b in the assembled state of the link bracket. As the second stop protrusion portion 12 is deformed in the inner direction of the coupling hole 22 by the pressing protrusion 31 of the punch 30, a second introduced volume portion B is formed in a portion corresponding to the depression 23b of the serration 23.

The second introduced volume portion B is pushed into the inner space of the depression 23b in an inclined shape. Furthermore, the front and rear surfaces of this portion are in close contact with the front and rear surfaces of the depression 23b in the circumferential direction. Accordingly, the rotational behavior of the link bracket 20 with respect to the pipe 10 may be suppressed.

The first introduced volume portion A and the second introduced volume portion B are formed such that the second stop protrusion portion 12 is more effectively pressed by the pressing protrusion 31 of the punch 30 and thus a more volume is introduced into the stepped portions 23aa of the protrusions 23a and the depressions 23b.

Furthermore, in the secondary swaging step, the end surface of the punch 30 is prevented from coming into contact with the link bracket 20. Accordingly, the second stop protrusion portion 12 may be compressed more strongly by further moving the pressing protrusion 31 toward the link bracket 20, which helps to increase the depths (the sizes of the introduced volumes) of the first introduced volume portion A and the second introduced volume portion B.

As described above, according to the present invention, the first introduced volume portion A and the second introduced volume portion B are formed to have large introduced volumes over the overall circumference of the serration 23, so that the rotational separation of the link bracket 20 from the pipe 10 may more reliably be suppressed.

Therefore, even in the case where a strong torsional moment is applied to the link bracket 10 when the height of the seat is adjusted, there is no rotational separation of the link bracket 20.

Therefore, the operation of adjusting the height of a seat may be performed more smoothly, and a user may feel a smooth operation feeling.

In addition, as described above, the rotational separation of the link bracket 20 is reliably prevented. There is no need to perform a full inspection after the rear link assembly has been manufactured. As a result, the manufacturing costs of the rear link assembly can be reduced.

According to the above-described present invention, the stepped portions are formed in the protrusions of the serration of each of the link brackets, and a portion of the volume of the second stop protrusion portion is introduced into the stepped portions, so that the coupling strength between the link brackets and the pipe in the rotation direction is increased.

Furthermore, the pressing protrusion is formed on the punch used for the swaging of the second stop protrusion portion, and the second stop protrusion portion is compressed more strongly, thereby increasing the volume introduced into the serration.

Therefore, since there is no rotational separation between the link brackets and the pipe, the operation of adjusting the height of a seat is performed smoothly, and a user's feeling about operation is improved.

In addition, since there is no separation between the link brackets and the pipe, there is no need to perform a full inspection after the manufacture of the rear link assembly, so that an effect is achieved in that the manufacturing costs of the rear link assembly are reduced.

While the present invention has been described with reference to the embodiments shown in the drawings, this is merely exemplary. Those of ordinary skill in the art will appreciate that various modifications and other equivalent embodiments may be possible therefrom. Therefore, the true technical protection range of the present invention should be defined based on the attached claims.

What is claimed is:

1. A rear link assembly for a vehicle seat, comprising;
a pipe provided with a first and a second stop protrusion portions in a vicinity of each end thereof;
a link bracket fixed between the first and second stop protrusion portions;
a serration formed by repeatedly forming pluralities of protrusions and depressions on an inner circumferential surface of a coupling hole of the link bracket into which the pipe is inserted;
stepped portions formed on the protrusions; and
a first introduced volume portion formed in such a manner that one side of the second stop protrusion portion is deformed and introduced into the stepped portions.

2. The rear link assembly of claim 1, further comprising a second introduced volume portion formed in such a manner that one side of the second stop protrusion portion is deformed and introduced into the depressions.

3. The rear link assembly of claim 1, wherein inner corners of the stepped portions are formed at a right angle.

4. The rear link assembly of claim 1, wherein:
a wall surface connecting the stepped portions and an outer surface of the coupling hole is formed as a flat surface; and
the flat surface is a flat surface in contact with a circumferential surface having a same center as the center of the coupling hole.

5. A method of manufacturing a rear link assembly for a vehicle seat, comprising:
a first swaging step of forming a first stop protrusion portion in a portion in a vicinity of each end of a pipe;
a link bracket installation step of installing a link bracket at the end of the pipe so that one side of the link bracket is supported on the first stop protrusion portion;
a second swaging step of forming a second stop protrusion portion configured to come into close contact with a remaining side of the link bracket; and
a step of forming a first introduced volume portion in such a manner that the second stop protrusion portion is deformed and introduced into the stepped portions formed in the protrusions of the serration formed on a coupling hole of the link bracket.

6. The method of claim 5, wherein a circular pressing protrusion is formed on an end surface of the punch used in the second swaging step, and presses the second stop protrusion portion toward the serration.

7. The method of claim 5, wherein:
a coupling hole configured such that the pipe is inserted into the link bracket therethrough, a serration formed on an inner circumferential surface of the coupling hole, and stepped portions formed on protrusions of the serration are formed; and
the coupling hole, the serration, and the stepped portions are simultaneously formed by a single piercing process.
